(19) United States
(12) Patent Application Publication
(10) Pub. No.: US 2007/0132144 A1
(43) Pub. Date: Jun. 14, 2007

(54) Partially compatibilized PVC composites

(76) Inventors: Miriam Rafailovich, Plainview, NY (US); Mayu Si, Stony Brook, NY (US); David Abecassis, Huntington, NY (US)

Correspondence Address: HOFFMANN & BARON, LLP, 6900 JERICHO TURNPIKE, SYOSSET, NY, 11791, US

(21) Appl. No.: 11/601,462

(22) Filed: Nov. 17, 2006

Related U.S. Application Data
(60) Provisional application No. 60/738,095, filed on Nov. 18, 2005.

(51) Int. Cl. C08L 23/00

(52) U.S. Cl. 264/310; 264/915; 525/240

(57) ABSTRACT

A composite material and a method of making a composite material that includes: a polyolefin; polyvinyl chloride and a compatibilizer, preferably a nanoclay. The polyolefins is preferably polypropylene or polyethylene. In a preferred embodiment, the composite material includes a polypropylene, a polyethylene, polyvinyl chloride and a nanoclay. The nanoclay includes a quaternary ammonium salt based organic group and exfoliates when heated and is most preferably bentonite, smectite, hectorite, sepiolite or montmorillonite.

This application claims priority from provisional application Ser. No. 60/738,095, filed on Nov. 18, 2005, which is incorporated herein in its entirety.

### FIELD OF THE INVENTION

The present invention relates to composite materials made from polyvinyl chloride and one or more polyolefins and methods for making the composites.

### BACKGROUND OF INVENTION

The plastic industry generates millions of pounds of plastic products each year including bottles, containers, bags, and a vast array of industrial and household products. Modem plastics possess a number of extremely desirable characteristics, including: high strength to weight ratio, excellent thermal properties, electrical insulation, and a high resistance to acids, alkalis and solvents. Moreover, because of the light weight, durability and the ease with which they can be formed into different shapes and structures at a relatively low cost, plastics have replaced wood and metal in many products. However, with all of the attractive properties of plastics, they pose a major disposal problem when they have outlived their usefulness.

Most plastics are not biodegradable, or biodegradation takes an impractical length of time. Therefore, burying plastic refuse in a landfill is not a practical disposal solution. Similarly, the incineration of plastics is unacceptable because of the toxic gasses that are generated. Thus, by a process of elimination, the favored choice for the disposal of plastic products is recycling. However, in most instances recycling plastic waste is simply not an economically viable solution.

Most of the plastics made today primarily use petroleum and other petrochemical products as the raw material. Plastics are polymers that consist of a series of repeating units known as monomers. The structure and degree of polymerization of a given polymer determine its characteristics. Linear polymers (a single linear chain of monomers) and branched polymers (a linear chain with side chains) are thermoplastic, that is they soften when heated. Cross-linked polymers (two or more chains joined by side chains) are thermosetting, that is they harden when heated.

Thermoplastics make up 80% of the plastics produced today. Examples of thermoplastics include: high density polyethylene (HDPE), used in piping, automotive fuel tanks, bottles, toys; low density polyethylene (LDPE), used in plastic bags, cling film, flexible containers; polyethylene terephthalate (PET), used in bottles, carpets and food packaging; polypropylene (PP), used in food containers, battery cases, bottle crates, automotive parts and fibers; polystyrene (PS), used in dairy product containers, tape cassettes, cups and plates; and polyvinyl chloride (PVC), used in window frames, flooring, bottles, packaging film, cable insulation, credit cards and medical products.

Thermoset plastics make up the remaining 20% of plastics produced. They are hardened by curing and cannot be re-melted or re-molded and are therefore difficult to recycle. They are sometimes ground up and used as a filler material. Examples of thermosets include: polyurethane (PU), used in coatings, finishes, gears, diaphragms, cushions, mattresses and car seats; epoxy, used in adhesives, sports equipment, electrical and automotive equipment; and phenols, used in ovens, handles for cutlery, automotive parts and circuit boards.

Polyvinyl chloride (PVC) is a widely used plastic. In terms of revenue generated, it is one of the most valuable products of the chemical industry. Globally, over 50% of PVC manufactured is used in construction. As a building material, PVC is cheap and easy to make and assemble. In recent years, PVC has been replacing traditional building materials such as wood, concrete and clay in many areas. As a hard plastic, it is used as vinyl siding, magnetic stripe cards, window profiles, gramophone records (which is the source of the name for vinyl records), pipe, plumbing and conduit fixtures. It can be made softer and more flexible by the addition of plasticizers, the most widely used being phthalates. In this form, it is used in clothing and upholstery, and to make flexible hoses and tubing, flooring, to roofing membranes, and electrical cable insulation. PVC is often used for pipelines in the water and sewer industries because of its inexpensive nature and flexibility.

However, despite appearing to be an ideal building material, concerns have been raised about the costs of PVC to the natural environment and human health. PVC gives off dioxins when burned at non-controlled temperature (i.e., low temperatures that don't produce complete burning) and hydrochloric acid can be produced by chemical degradation. The degradation products, such as monomers, are often hazardous and small enough to leach out of the plastic over time. PVC is recognized as one of the most environmentally hazardous plastics. Accordingly, it has been increasingly important to find ways to recycle and reuse PVC products and matrials.

Polypropylene or polypropene (PP) is a thermoplastic polymer, which is used in a wide variety of applications, including food packaging, textiles, plastic parts and reusable containers of various types, laboratory equipment, loudspeakers, automotive components, and polymer banknotes. An addition polymer made from the monomer propylene, it is rugged and unusually resistant to many chemical solvents, bases and acids. These very properties that make polypropylene so useful also make it very difficult to recycle polypropylene. Accordingly, there is a need for a process for recycling polypropylene into useful products.

Polyethylene (PE) is a thermoplastic material that is used extensively in consumer products. Polyethylene is created through polymerization of ethene and it is classified into several different categories based mostly on its density and branching. The mechanical properties of PE depend significantly on variables such as the extent and type of branching, the crystal structure, and the molecular weight. The different types of polyethylene include: ultra high molecular weight PE (UHMWPE); high molecular weight polyethylene (HMWPE); high density PE (HDPE); high density cross-linked PE (HDXLPE); cross-linked PE (PEX); medium density PE (MDPE); low density PE (LDPE); linear low density PE (LLDPE); and very low density PE (VLDPE). Depending on the crystallinity and molecular weight, a melting point and glass transition of a particular type of polyethylene may or may not be observable. The temperature at which these occur varies with the type of polyethylene. The different polyethylenes have a wide variety of uses including building materials, consumer products and packaging materials.

Many plastics are not recyclable because they can not be reformed into useful products. However, many plastics can be recycled, most commonly: polyethylene (PE)-high density, medium density and low-density polyethylene; polypropylene (PP); polystyrene (PS); polyvinyl chloride (PVC). A common problem encountered when recycling plastics is that many plastic products are often made up of more than one kind of polymer or fiber may be added to the plastic (a composite) to provide added strength. For example, the food industry often uses multiple layers in its products to provide different characteristics, one or more layers for strength and/or durability, a gas barrier layer and an outer layer for printing. In other cases, the plastic products may have be reinforced with a metal or a fiber in order to provide added strength. This can make recycling difficult and expensive.

PVC, polypropylene and polyethylene are used for a wide variety of materials and products and are often mixed together during the recycling of plastic materials. As a consequence, polypropylene and/or polyethylene and PVC are often found together in unusable mixtures which cannot be easily combined into useful composite materials. For example, when electrical wires and cables are recycled, the copper is removed and the plastic covering is discarded. Since different types of electrical wire have coverings made from different types of plastics, the plastic that is left over from recycling wires/cables is a mixture of different plastics, with the most commonly used plastics being PVC, polyethylene and polypropylene. This makes recycling the plastic more difficult and more expensive. Therefore, there is a need for a method of efficiently and inexpensively recycling mixtures of different types of plastics.

Extensive research has been conducted on polymer-polymer blends, both miscible and immiscible. The prior art discloses methods for blending polymers for improved impact strength, increased elasticity and easier processability. Attempts to compatibilize PVC and polyolefin have been directed to chemical grafts or block copolymers and chemical compatibility of the functional groups of the polymers. Other attempts to reclaim PVC, PP and/or PE have used physical methods to separate the different plastics based on density and wettability. However, these attempts have been mostly unsuccessful because most polymers are immiscible and have only a minimal increase in entropy when blended. This is one of the reasons why PVC and polyolefins, such as PE, PP, are not miscible and, if melt blended, phase separate and cannot be processed as a homogeneous blend.

Currently, mixtures of PVC and polypropylene and/or polyethylene are considered unusable as a mix by the plastics industry, since they can not be easily blended together and formed into useful products. Accordingly, there is a need for a method that will allow different plastic materials to be easily and economically combined to form useful composite materials that are environmentally safe.

### SUMMARY OF THE INVENTION

The present invention is a composite material that includes: a polyolefin; polyvinyl chloride and a compatibilizer, preferably a nanoclay. The polyolefin is preferably polypropylene or polyethylene. In a preferred embodiment, the composite material includes a polypropylene, a polyethylene, polyvinyl chloride and a nanoclay. The nanoclay preferably includes a quaternary ammonium salt based organic group and exfoliates when heated and is most preferably bentonite, smectite, hectorite, sepiolite or montmorillonite.

The composite material preferably contains from about 1 to about 99% by weight polyolefin, from about 1 to about 99% by weight polyvinyl chloride, and from about 1 to about 10% by weight nanoclay. More preferably, the composite material contains from about 10 to about 90% by weight polyolefin, from about 10 to about 90% by weight polyvinyl chloride, and from about 1 to about 10% by weight nanoclay. In one preferred embodiment, the composite material contains from about 1 to about 99% by weight polypropylene, from about 1 to about 99% by weight polyethylene, from about 1 to about 99% by weight polyvinyl chloride, and from about 1 to about 10% by weight nanoclay.

In another embodiment, the invention is a method of making a composite material that includes: combining a polyolefin, preferably polypropylene or polyethylene, having a first melting temperature and a polyvinyl chloride having a second melting temperature to form a first mixture; heating the first mixture to a temperature greater than the first melting temperature and the second melting temperature; adding a nanoclay to the first mixture to form a second mixture; heating the second mixture to a temperature greater than the first melting temperature and the second melting temperature; and mixing the second mixture until it is substantially homogeneous and the nanoclay exfoliates. The nanoclay can include a quaternary ammonium salt based organic group.

In preferred embodiment, the invention is a method of making a composite material that includes: combining a polyethylene having a first melting temperature, a polypropylene having a second melting temperature and a polyvinyl chloride having a third melting temperature to form a first mixture; heating the first mixture to a temperature greater than the first, second and third melting temperatures; adding a nanoclay to the first mixture to form a second mixture, wherein the nanoclay comprises a quaternary ammonium salt based organic group; heating the second mixture to a temperature greater than the first, second and third melting temperatures; and mixing the second mixture until it is substantially homogeneous and the nanoclay exfoliates. In preferred embodiments, the second mixture is then formed into an article by a rotational molding, extruding or injection molding. The second mixture can also be co-extruded onto a matrix, a support or a component.

In a preferred embodiment, the present invention is a method of recycling plastic composite material from electrical wire. The method includes: providing a plurality of electrical wires for recycling, wherein each of the plurality of electrical wires comprises a metal conductor and a plastic covering, and wherein the plastic coverings include at least two different types of plastics; separating the metal conductors in the plurality of wires from the plastic coverings; cutting the plastic coverings into a plurality of plastic segments; combining the plurality of plastic segments; heating the plurality of plastic segments, preferably to a temperature of at least 200° C., to form a liquid mixture; adding a nanoclay, preferably a nanoclay that includes a quaternary ammonium salt based organic group, in an amount of from about 1% to about 10% by weight of the liquid mixture; mixing the nanoclay and liquid mixture until a substantially miscible composition is formed; and cooling the substantially miscible composition to form a composite material. The plastic coverings preferably include polyvinyl chloride and polypropylene or polyethylene.

### DETAILED DESCRIPTION OF THE INVENTION

The present invention relates to plastic composites made from PVC and one or more polyolefins. In a preferred embodiment, the composites of the present invention are made using a universal compatibilizer, which allows one or more polyolefins and PVC to be combined to form a miscible blend. The result is new composite materials which can be made from what is now considered to be unusable plastic waste.

The present invention solves the problem of recycling PVC by combining discarded PVC with a nanoclay and one or more polyolefins to form a useable composite material. The composite materials have excellent properties, such as high gas barrier properties and high chemical resistance. In addition, the PVC is substantially less flammable than the polyolefins and makes the composite materials less flammable than most plastics.

In a preferred embodiment, the present invention is a composite material made from polypropylene and/or polyethylene and PVC, which can be mixed and processed together using conventional plastics processing equipment. The polypropylene and/or polyethylene and PVC are mixed and processed together with exfoliated clay to form a miscible composite material. It has been found that exfoliated clay or “nanoclays” can be used to compatibilize blends of different polymers so that they do not separate after they are blended together. Separation of polymer blends is one of the problems encountered when recycling mixtures of different plastics. For example, PVC and PP is one of the most immiscible blends of polymer materials. However, using the method of the present invention, these materials have been successfully blended into a useable material.

PVC

The present invention forms composite materials from PVC and one or more polyolefins. The PVC can be rigid high molecular weight PVC, medium weight PVC or low molecular weight PVC. In general, PVC has a glass temperature of about 87° C. and a melting point (or melt temperature) of about 212° C. However, these temperatures vary according to the type of PVC.

The concentration of the PVC component is from about 1% by weight to about 99% by weight of the composite material and, preferably, from about 10% by weight to about 90% by weight of the composite material.

Polyolefins

A variety of different polyolefins can be combined with PVC to form the composite materials of the present invention. The preferred polyolefins are polypropylenes, including low, medium and high density polypropylene, and polyethylenes (linear or branched), including very, low, low, medium and high density polyethylenes. The polypropylenes have a glass temperature of about −10° C. and a melting point (or melt temperature) of about 165° C., which will vary depending on the type of polypropylene that is used. For common commercial grades of medium-density and high-density polyethylene, the melting point is typically in the range 120-130° C. The melt point for average commercial low-density polyethylene is typically 105-115° C. In addition, PE-PP copolymers can be used.

The concentration of the polyolefin component is from about 1% by weight to about 99% by weight of the composite material and, preferably, from about 10% by weight to about 90% by weight of the composite material. The amounts of PVC and polyolefin depend on the desired properties of the composite material that is formed.

Nanoclay

The nanoclay can have a quaternary ammonium salt based organic group or any other treatment which causes separation of the clay into single crystals. Preferred nanoclays are bentonites, smectites, hectorites, sepiolites, montmorillonites. However, any other clay species can be used where the clay crystals separate or exfoliate after treatment with quaternary amines or comparable chemical surfactant. Preferred crystals are one molecule layer thick on the profile and are susceptible to exfoliation in the melt phase of one or more of the plastics in the composite material.

Preferred nanoclays that can be used in the composite materials of the present invention are described in U.S. Pat. No. 6,339,121 to Rafailovich, et al., which is incorporated herein in its entirety. The concentration of the nanoclay can vary between from about 1% by weight to about 20% by weight of the composite material, preferably between about 1% by weight and 10% by weight of the composite material. Preferred nanoclays are CLOISITE® 15A and CLOISITE® 20A from Southern Clay Products, Inc., Gonzales, Tex.

In preferred embodiments, the compounds with size to aspect ratios similar to those found with exfoliated clays and carbon nanotubes are used in place of the nanoclays. These compounds act as a compatibilizer and prevent the PVC-polyolefins from separating after they have been blended together.

The present invention also includes a method for making the composite materials. The PVC and one or more polyolefins are mixed together and then heated. As discussed above, PVC and the polyolefins have different melting temperatures. When the mixture is heated, it should be heated to a temperature greater than or equal to the highest melting temperature of the materials in the mixture. This ensures that all of the materials are in a liquid state and can be blended together. The nanoclay is then added to the mixture and the mixture is mixed until it is substantially homogeneous and the nanoclay is substantially exfoliated. The composite material can then be formed into blocks and cooled or processed in to an article or product by a rotational molding, extruding or injection molding.

In a preferred embodiment, the method is used to recycle plastic from electrical wire. When electrical wiring is recycled to recover the copper conductor the plastic covering, also referred to as the “jacket” or insulation, is usually discarded. The covers are made from a variety of plastics, typically PVC and different types of polypropylenes and polyethylenes. Since the leftover covers are made of different plastics, they are difficult to recycle. The present method solves the problem by recycling the different plastics together. After the conductors are removed, the discarded plastic covers are cut up into smaller segments to make them easier to handle. The cutting step can be done using any one of a variety of well known methods to reduce the plastic coverings to a size that is more convenient for handling and processing. Very often the process used to remove the metal conductor will shred the plastic covers into segments.

The plurality of plastic segments formed by the cutting step are then combined and heated, preferably to a temperature of at least 200° C., and more preferably to a temperature of at least 220° C., to form a liquid mixture. The temperature is selected based on the melting temperatures of the plastics being recycled. The plastic segments must be heated to a temperature at least as high as the highest melting temperature of all the different plastics. In most cases, this is PVC with a melt temperature of about 212° C.

After the plastic segments are formed into a liquid mixture, a nanoclay, preferably a nanoclay that includes a quaternary ammonium salt based organic group, is added. The amount of nanoclay added is from about 1% to about 10% by weight of the liquid mixture and can vary depending on the plastics. High percentages of PVC in the mixture require greater amounts of nanoclay. The nanoclay/liquid mixture is heated and mixed until a substantially miscible composition is formed. Usually, this can be visually observed or samples can be taken to determine the miscibility of the mixture. If the required miscibility is not obtained, additional nanoclay is added. After the nanoclay and the liquid have been formed into a homogenous composition, the composition can be used to form articles or products using well known extruding or molding methods. The substantially miscible composition can also be formed into blocks and cooled to form a composite material that can be used as a raw material.

Preferred composite materials use polypropylene and/or polyethylene as the polyolefin component of the composite material. The polyolefin and PVC can be combined in a variety of different amounts. For example, in one embodiment the composite material could include about 10% nanoclay, about 10% PVC and about 80% polypropylene. In another embodiment, the composite material could include about 10% nanoclay, about 20% PVC and about 70% polyethylene. In a third embodiment. the composite material could include about 10% nanoclay, about 30% PVC and about 60% polypropylene. In a fourth embodiment, the composite material could include about 10% nanoclay, about 40% PVC and about 50% polypropylene.

In another embodiment, the composite materials of the present invention can be mixed and processed together with one or more additives. Preferred additives are grades of Elvax® (ethylene vinylacetate) ranging from Grades 150-550. The composite materials made from polypropylene and/or polyethylene and PVC can also be mixed and processed with ethylene-propylene (EP) rubber, which uses a peroxide cure system, and/or ethylene propylene diene methylene terpolymer (EPDM) which uses a sulfur cure system. These rubbers would be used in place of the polyolefin or to supplement the polyolefin.

In another embodiment, the composite materials made from polypropylene and PVC are mixed and processed together with Maleic anhydride grafted polypropylene (PP) or polyethylene (PE). The composite material made from polypropylene and PVC can also be mixed and processed together with polybutadiene.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A composite material comprising:
a polyolefin;
polyvinyl chloride; and
a nanoclay.

2. The composite material according to claim 1, wherein the polyolefinis polypropylene or polyethylene.

3. The composite material according to claim 1, wherein the nanoclay exfoliates when heated.

4. The composite material according to claim 1, wherein the nanoclay comprises a quaternary ammonium salt based organic group.

5. The composite material according to claim 1, wherein the polyolefin comprises from about 1 to about 99% by weight of the composite material, wherein the polyvinyl chloride comprises from about 1 to about 99% by weight of the composite material, and wherein the nanoclay comprises from about 1 to about 10% by weight of the composite material.

6. The composite material according to claim 1, wherein the polyolefin comprises from about 10 to about 90% by weight of the composite material , wherein the polyvinyl chloride comprises from about 10 to about 90% by weight of the composite material, and wherein the nanoclay comprises from about 1 to about 10% by weight of the composite material.

7. The composite material according to claim 1, wherein the nanoclay is bentonite, smectite, hectorite, sepiolite or montmorillonite.

8. A composite material comprising:
from about 1 to about 99% by weight of a polypropylene or polyethylene;
from about 1 to about 99% by weight of polyvinyl chloride; and
from about 1 to about 10% by weight of a nanoclay, wherein the nanoclay exfoliates when heated and comprises a quaternary ammonium salt based organic group.

9. A method of making a composite material comprising:
combining a polyolefin having a first melting temperature and a polyvinyl chloride having a second melting temperature to form a first mixture;
heating the first mixture to a temperature greater than the first melting temperature and the second melting temperature;
adding a nanoclay to the first mixture to form a second mixture;
heating the second mixture to a temperature greater than the first melting temperature and the second melting temperature; and
mixing the second mixture until it is substantially homogeneous and the nanoclay exfoliates.

10. The method of making a composite material according to claim 9, wherein the nanoclay comprises a quaternary ammonium salt based organic group.

11. The method of making a composite material according to claim 9, wherein the polyolefin is a polypropylene.

12. The method of making a composite material according to claim 11, wherein the first mixture further comprise a polyethylene having a third melting temperature that is less than the first melting temperature.

13. The method of making a composite material according to claim 9, wherein the polyolefin comprises from about 1 to about 99% by weight of the composite material, wherein the polyvinyl chloride comprises from about 1 to about 99% by weight of the composite material, and wherein the nanoclay comprises from about 1 to about 10% by weight of the composite material.

14. The method of making a composite material according to claim 9, wherein the nanoclay is bentonite, smectite, hectorite, sepiolite or montmorillonite.

15. The method of making a composite material according to claim 9, wherein the polyolefin is a polyethylene.

16. A method of making a composite material comprising:
combining a polyethylene having a first melting temperature, a polypropylene having a second melting temperature and a polyvinyl chloride having a third melting temperature to form a first mixture;
heating the first mixture to a temperature greater than the first, second and third melting temperatures;
adding a nanoclay to the first mixture to form a second mixture, wherein the nanoclay comprises a quaternary ammonium salt based organic group;
heating the second mixture to a temperature greater than the first, second and third melting temperatures; and
mixing the second mixture until it is substantially homogeneous and the nanoclay exfoliates.

17. The method of making a composite material according to claim 16, wherein the nanoclay is bentonite, smectite, hectorite, sepiolite or montmorillonite.

18. The method of making a composite material according to claim 16, wherein the polypropylene comprises from about 1 to about 99% by weight of the composite material, wherein the polyethylene comprises from about 1 to about 99% by weight of the composite material, wherein the polyvinyl chloride comprises from about 1 to about 99% by weight of the composite material, and wherein the nanoclay comprises from about 1 to about 10% by weight of the composite material.

19. The method of making a composite material according to claim 16, further comprising rotational molding, extruding or injection molding the second mixture to form an article.

20. The method of making a composite material according to claim 16, further comprising co-extruding the second mixture onto a matrix, a support or a component.

21. A method of recycling plastic composite material from electrical wire comprising:
providing a plurality of electrical wires for recycling, wherein each of the plurality of electrical wires comprises a metal conductor and a plastic covering, and wherein the plastic coverings comprise at least two different types of plastics;
separating the metal conductors in the plurality of wires from the plastic coverings;
cutting the plastic coverings into a plurality of plastic segments;
combining the plurality of plastic segments;
heating the plurality of plastic segments to form a liquid mixture;
adding a nanoclay in an amount of from about 1% to about 10% by weight of the liquid mixture;
mixing the nanoclay and liquid mixture until a substantially miscible composition is formed; and
cooling the substantially miscible composition to form a composite material.

22. The method of recycling plastic composite material from electrical wire according to claim 21, wherein the plastic coverings comprise polyvinyl chloride and polypropylene or polyethylene.

23. The method of recycling plastic composite material from electrical wire according to claim 21, wherein the plurality of plastic segments are heated to at least 200° C.

24. The method of recycling plastic composite material from electrical wire according to claim 21, wherein the nanoclay comprises a quaternary ammonium salt based organic group.
